(19) United States
(12) Patent Application Publication
(10) Pub. No.: US 2025/0368536 A1
(43) Pub. Date: Dec. 4, 2025

(54) CATHODE ACTIVE MATERIAL AND METHOD FOR PRODUCING CATHODE ACTIVE MATERIAL

(71) Applicant: TOYOTA JIDOSHA KABUSHIKI KAISHA, Toyota-shi (JP)

(72) Inventors: Ryosuke OHSAWA, Okazaki-shi (JP); Takahiko Ninomiya, Miyoshi-shi (JP); Taku Kinoshita, Toyota-shi (JP)

(73) Assignee: TOYOTA JIDOSHA KABUSHIKI KAISHA, Toyota-shi (JP)

(21) Appl. No.: 19/059,824

(22) Filed: Feb. 21, 2025

(30) Foreign Application Priority Data
May 31, 2024 (JP) 2024-089008

(51) Int. Cl. C01G 53/506

(52) U.S. Cl. CPC C01G 53/506; C01P 2002/30; C01P 2004/61; C01P 2004/62; C01P 2006/40

(57) ABSTRACT

The cathode active material includes secondary particles. The secondary particle includes a plurality of crystallites. Each of the plurality of crystallites includes a lithium metal composite oxide. A structure of the lithium metal composite oxide is a layered-rocksalt structure. In the cross section of the secondary particle, “2.5≤d_{L}/d_{S}≤15”, “0.051≤d_{L}/D≤0.124”, and “θ≤45°” are satisfied. “d_{L}” indicates the major axis diameter of the crystallite. “d_{S}” indicates the minor axis diameter of the crystallite. “D” indicates the maximum Feret diameter of the secondary particles. “θ” represents an angle formed between the first straight line and the second straight line. The first straight line is an extension of the major axis diameter of the crystallite. The second straight line passes through the intersection of the circumscribed circle of the secondary particle and the extension line and the center of the circumscribed circle.

### CROSS-REFERENCE TO RELATED APPLICATION

This application claims priority to Japanese Patent Application No. 2024-089008 filed on May 31, 2024, incorporated herein by reference in its entirety.

### BACKGROUND

### 1. Technical Field

The present disclosure relates to a cathode active material and a method for producing the cathode active material.

### 2. Description of Related Art

Japanese Unexamined Patent Application Publication No. 2019-145204 (JP 2019-145204 A) discloses a cathode active material including voids at a ratio of 20% or more and a long void through which the voids communicate with the inside of the particle.

### SUMMARY

The cathode active material includes a secondary particle. The secondary particle includes a plurality of crystallites (primary particles). Depending on the arrangement of the crystallites in the secondary particle, there is a possibility that lithium (Li) cannot smoothly enter and exit the crystallites. As a result, the initial resistance may increase.

An object of the present disclosure is to reduce initial resistance.

A cathode active material includes
a secondary particle.

The secondary particle includes a plurality of crystallites.

Each of the crystallites includes a lithium metal composite oxide.

The lithium metal composite oxide has a layered-rocksalt structure.

In a cross section of the secondary particle, relationships of “2.5≤d_{L}/d_{S}≤15,” “0.051≤d_{L}/D≤0.124,” and “θ≤45°” are satisfied.

The symbol “d_{L}” represents a major axis diameter of the crystallite. The symbol “d_{S}” represents a minor axis diameter of the crystallite.

The symbol “D” represents a maximum Feret diameter of the secondary particle.

The symbol “θ” represents an angle formed between a first straight line and a second straight line.

The first straight line is an extension line of the major axis diameter of the crystallite.

The second straight line passes through an intersection of a circumscribed circle of the secondary particle and the extension line and through a center of the circumscribed circle.

FIG. 1 is a conceptual diagram showing a first example of a secondary particle structure. A secondary particle 2 is an aggregate of crystallites 1 (primary particles). The crystallite 1 includes a layered-rocksalt structure. The layered-rocksalt structure is formed by alternately laminating host layers 1a and guest layers 1b. Li enters and exits the guest layer 1b. An end face 1c intersecting the guest layer 1b includes an Li access port. Depending on the arrangement of the crystallites 1 in the secondary particle 2, there is a possibility that Li cannot smoothly enter and exit the guest layer 1b.

FIG. 2 is a conceptual diagram showing a second example of the secondary particle structure. In FIG. 2, the crystallite 1 has a shape with a large aspect ratio. The crystallites 1 are arranged radially outward from the center of the secondary particle 2. The end face 1c includes the Li access port. The end face 1c is exposed to the outside of the secondary particle 2. Therefore, Li can smoothly enter and exit the crystallite 1. Further, the major axis direction of the crystallite 1 is substantially parallel to the in-plane direction of the guest layer 1b. Thus, the diffusion of Li in the guest layer 1b may be rectified. The synergy of these actions is expected to reduce the initial resistance.

In the above, “d_{L}/d_{S}” represents an aspect ratio of the crystallite, “d_{L}/D” represents a size ratio of the crystallite to the secondary particle, and “θ” represents an arrangement angle. It is considered that the crystallites are arranged more radially as the arrangement angle (θ) decreases. When the relationships of “2.5≤d_{L}/d_{S}≤15,” “0.051≤d_{L}/D≤0.124,” and “θ≤45°” are satisfied, the Li diffusion structure shown in FIG. 2 may be formed in the secondary particle 2. That is, the initial resistance is expected to be reduced.

The cathode active material described above may include, for example, the following configuration. In the cross section of the secondary particle, relationships of “0.051≤d_{L}/D≤0.094” and “2.5≤d_{L}/d_{S}≤7.4” are further satisfied.

When the above relationships are satisfied, the initial resistance is expected to be reduced.

The cathode active material described above may include, for example, the following configuration. In the cross section of the secondary particle, the secondary particle has a voidage of 5.7% or less.

Due to the moderately dense secondary particle, the initial resistance is expected to be reduced.

The cathode active material described above may include, for example, the following configuration. A standard deviation of the “d_{L}/d_{S}” is 1.0 to 6.3.

Since the aspect ratio (d_{L}/d_{S}) has a moderate variation, the initial resistance is expected to be reduced.

A method for producing a cathode active material includes the following steps.

A metal hydroxide is prepared.

A first mixture is formed by mixing the metal hydroxide and a lithium compound.

A second mixture is formed by subjecting the first mixture to first heat treatment.

The cathode active material is synthesized by subjecting the second mixture to second heat treatment.

The first heat treatment and the second heat treatment are performed under an oxygen atmosphere.

The first heat treatment is performed at a temperature of 600° C. to 650° C. for 1 hour to 5 hours.

The second heat treatment is performed at a temperature of 900° C. to 1100° C. for 0.5 hours to 2 hours.

The heat treatment is also referred to as “firing.” In the above “5”, two-stage short-time firing is performed. That is, the first heat treatment is performed at a low temperature for a short time. The second heat treatment is performed at a high temperature for a short time. Particle growth of the crystallites may proceed during the firing. The combination of the first heat treatment and the second heat treatment may impart a particular anisotropy to the particle growth of the crystallites. That is, the crystallites may grow such that the major axis of the crystallites extends along the in-plane direction of the host layer and the guest layer of the layered-rocksalt structure. Further, the secondary particle may be formed by radially arranging the crystallites. Since the firing is performed for a short time, it is considered that the crystallites cannot grow large. The secondary particle may be an aggregate of fine crystallites. The synergy of these actions is expected to reduce the initial resistance.

It is considered that the orientation relationship between each of the host layer and the guest layer of the layered-rocksalt structure and the major axis of the crystallites cannot be determined from the appearance of the crystallites in, for example, a sectional image of the secondary particle obtained by a scanning electron microscope (SEM). Therefore, even if the shapes of the secondary particle and the crystallites are similar in appearance to those in the present disclosure, the orientation relationship is not necessarily similar to that in the present disclosure. The orientation relationship may be determined, for example, by transmission electron microscopy (TEM) analysis described later.

An embodiment of the present disclosure (hereinafter also simply referred to as “present embodiment”) and an example of the present disclosure (hereinafter also simply referred to as “present example”) will be described below. However, the present embodiment and the present example are not intended to limit the technical scope of the present disclosure. The present embodiment and the present example are illustrative in all respects. The present embodiment and the present example are not restrictive. The technical scope of the present disclosure includes all modifications that fall within the meaning and scope equivalent to the claims. For example, it is originally planned to extract any desired configurations from the present embodiment and combine them as desired.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a conceptual diagram showing a first example of a secondary particle structure;

FIG. 2 is a conceptual diagram illustrating a second example of a secondary particle structure;

FIG. 3 is a conceptual diagram showing a method of measuring an arrangement angle (θ);

FIG. 4 is a schematic flow chart of a process for producing a cathode active material according to the present embodiment; and

FIG. 5 is a table showing production conditions and experimental results.

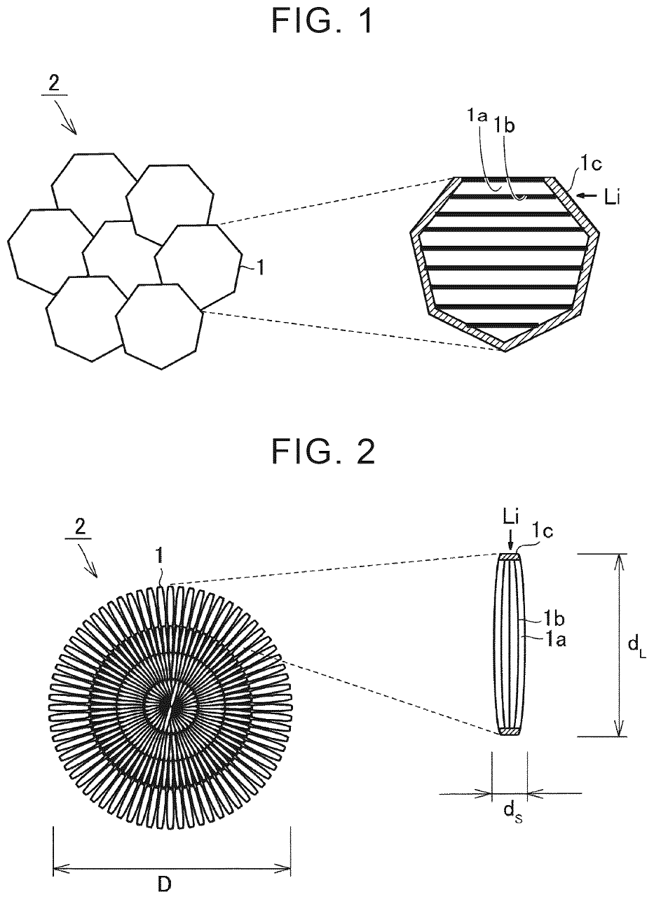

### DETAILED DESCRIPTION OF EMBODIMENTS

### Terms and Phrases

Geometric terms should not be construed in a strict sense. Examples of the geometric terms include “parallel”, “vertical”, and “orthogonal”. For example, “parallel” may deviate somewhat from “parallel” in a strict sense. For example, directions, angles, distances, and the like may be relatively displaced within a range in which substantially the same function is obtained. The geometric terms may include, for example, design-related, work-related, or manufacturing-related, tolerances, variations, and so forth. Dimensional relationships in each drawing may not match actual dimensional relationships. The dimensional relationships in the drawings may be changed to facilitate understanding by readers. For example, the length, width, thickness, and so forth, may be changed. Some configurations may be omitted.

Numerical ranges such as “m to n %” include upper and lower limits unless otherwise specified. That is, “m to n %” indicates a numerical range of “m % or more and n % or less”. In addition, “m % or more and n % or less” includes “more than m % and less than n %”. The terms “greater than or equal to” and “less than or equal to” are represented by an equal signed inequality sign “≤, ≥”. “Super” and “less than” are represented by inequality signs “<, >” that do not include equal signs.

All numerical values are modified by the term “approximately.” The term “approximately” can mean, for example, ±5%, ±3%, ±1%, and the like. All numerical values can be approximations that may vary depending on the mode of use of the disclosed technique. All numerical values can be displayed with significant digits. The measured value may be an average value in a plurality of measurements unless otherwise specified. The number of measurements may be three or more, five or more, or ten or more. In general, it is expected that the reliability of the average value improves as the number of measurements increases. The measured value can be rounded by rounding based on the number of significant digits. The measured value can include errors and the like associated with, for example, the detection limit of a measuring device.

“Crystalline” refers to a solid particle having a boundary between particles that is the smallest unit of the particle and that is recognized as incapable of being further subdivided. “Secondary particle” refers to an aggregate of two or more crystallites.

“Crystalline major axis diameter (d_{L})”, “crystallite minor axis diameter (d_{S})”, “secondary particle maximum Ferret diameter (D)”, “orientation angle (θ)”, “porosity (ε)” are measured in cross-sectional SEM images of secondary particles. The observation magnification can be adjusted according to the particle size. The observation magnification may be, for example, about 1000 times. The cross-sectional sample of the particles can be prepared by a conventionally known method. For example, CP (Cross Section Polisher), FIB (Focused Ion Beam) and the like may be used to prepare cross-sectional samples. Various dimensions and angles in the image are measured by image analysis software. For example, “ImageJFiji” or the like may be used. It should be noted that “ImageJFiji” is merely an example. Any image-analysis software can be used as long as it has a function equivalent to “ImageJFiji”. For example, image-analysis software attached to various SEM devices may be used.

In the cross-sectional SEM images of the secondary particles, the smallest rectangle circumscribing the crystallite (hereinafter also referred to as “circumscribing rectangle”) is identified. The length of the long side of the circumscribed rectangle is “long axis diameter (d_{L})”. The length of the short side of the circumscribing rectangle is “the minor axis diameter (d_{S})”. The standard deviation (σ) of the aspect ratio (d_{L}/d_{S}) may be calculated from 20 or more data.

In the cross-sectional SEM images of the secondary particles, the distance between the two most distant points on the contour line of the secondary particles is the “maximum Feret diameter (D)”.

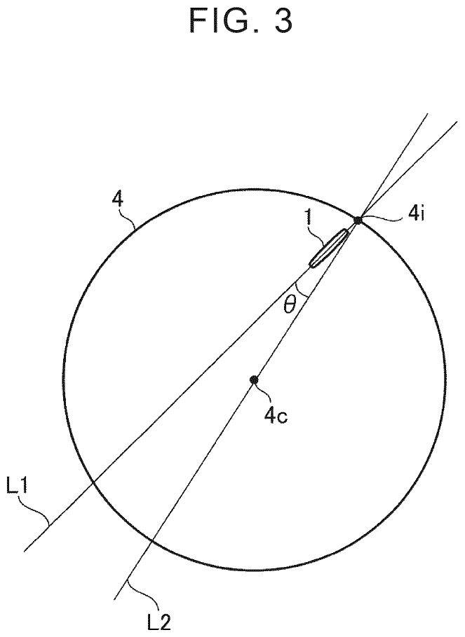

FIG. 3 is a conceptual diagram illustrating a method of measuring an orientation angle (θ). In the cross-sectional SEM images of the secondary particles, the circumscribed circle 4 of the secondary particles is identified. The crystallites 1 exposed on the surface of the secondary particles are selected. The first straight line L1 is specified by extending the major axis diameter (d_{L}) of the crystallite 1. That is, the first straight line L1 is an extension of the major axis diameter (d_{L}). An intersection 4i between the first straight line L1 and the circumscribed circle 4 is specified. A second straight line L2 passing through the intersection 4i and the center 4c of the circumscribed circle 4 is identified. The orientation angle (θ) is an angle (acute angle) formed between the first straight line L1 and the second straight line L2.

By binarization of cross-sectional SEM images of secondary particles, the voids and crystallites are identified. The “porosity (ε)” is obtained by dividing the number of pixels of the void by the total number of pixels of the void and the crystallite. The porosity (ε) is expressed as a percentage.

“D50” refers to the particle size at which the integration is 50% in the volume-based particle size distribution (integrated distribution). The particle size distribution can be measured by laser diffraction methods.

The stoichiometric composition formula represents a representative example of a compound. The compound may have a non-stoichiometric composition. For example, “Al₂O₃” is not limited to compounds having a material ratio (molar ratio) of “Al/O=2/3”. Unless otherwise noted, “Al₂O₃” refers to compounds containing Al and O in any material fraction. For example, the compound may be doped with a trace element. Some of Al and O may be substituted with another element.

### Cathode Active Material

Hereinafter, the cathode active material in the present embodiment may be abbreviated as “the present cathode active material”. The cathode active material is for a secondary battery. That is, the present disclosure also provides a “positive electrode including the present cathode active material” and a “secondary battery including the present cathode active material”. The secondary battery may be, for example, a liquid-based battery, a polymer battery, or an all-solid-state battery. The secondary battery may be, for example, a monopolar battery or a bipolar battery.

The cathode active material includes secondary particles. The cathode active material may be an aggregate (powder) of secondary particles. D50 of the cathode active material, for example, 0.1 μm or more, 1 μm or more, 5 μm or more, or may be 10 μm or more. D50 may be, for example, 30 μm or less, 25 μm or less, 20 μm or less, 15 μm or less, or 10 μm or less.

### Secondary Particle

As shown in FIG. 2, the secondary particles 2 are an aggregate of crystallites 1. The secondary particles 2 have any shape. The secondary particles 2 may have, for example, a spherical shape, an elliptical spherical shape, a lump shape, or the like. In the cross-sectional SEM images of the secondary particles 2, the outline of the secondary particles 2 may have, for example, a circularity of 0.8 or more. The circularity may be, for example, 0.85 or more, 0.90 or more, or 0.95 or more. “Circularity (Cr)” is determined by the equation:

$$Cr = 4 π S / {L}^{2}$$

π: Circumferential ratio
S: Cross-sectional area of the secondary particle 2 (area of the area surrounded by the contour line of the secondary particle 2)
L: Circumferential length of the secondary particle 2 (length of the contour line of the secondary particle 2)

The maximum Feret diameter (D) of the secondary particles 2 may be, for example, 1 μm or more, 5 μm or more, 10 μm or more, 10.5 μm or more, 11.5 μm or more, 12.4 μm or more, 16.5 μm or more, 18.2 μm or more, or 20 μm or more. The maximum Feret diameter (D) may be, for example, 30 μm or less, 25 μm or less, 20 μm or less, 18.2 μm or less, 16.5 μm or less, 12.4 μm or less, 11.5 μm or less, 10.5 μm or less, or 10 μm or less.

The porosity (ε) of the secondary particles 2 may be, for example, 9.6% or less, 8.2% or less, 5.7% or less, 5.2% or less, 4.6% or less, or 3% or less. The porosity (ε) may be, for example, 1% or more, 2% or more, 3% or more, 4.6% or more, 5.2% or more, 5.7% or more, or 8.2% or more.

### Crystallite

The secondary particle 2 includes a plurality of crystallites 1. In the cross-sectional SEM images of the secondary particles 2, the number of the crystallites 1 included in one secondary particle 2 may be, for example, 10 or more, 50 or more, 100 or more, 150 or more, or 200 or more. The number of crystallites 1 included in one secondary particle 2 may be, for example, 500 or less, 250 or less, 200 or less, 150 or less, 100 or less, or 50 or less.

In this cathode active material, the relation of “0.051≤d_{L}/D≤0.124” is satisfied. The size-ratio (d_{L}/D) may be, for example, 0.094 or less, or 0.075 or less. The size-ratio (d_{L}/D) may be, for example, 0.075 or more, or 0.094 or more. That is, the relation “0.051≤d_{L}/D≤0.094” may be satisfied.

In the present cathode active material, the relation of “2.5≤d_{L}/d_{S}≤15” is satisfied. The aspect ratio (d_{L}/d_{S}) may be, for example, 3.1 or more, 5 or more, 7.4 or more, 10 or more, or 12.5 or more. The aspect ratio (d_{L}/d_{S}) may be, for example, 12.5 or less, 10 or less, 7.4 or less, 5 or less, or 3.1 or less. That is, the relation “2.5≤d_{L}/d_{S}≤7.4” may be satisfied.

The standard deviation (σ) of the aspect ratio may be, for example, 1.0 to 6.3. The standard deviation (σ) of the aspect ratio may be, for example, 1.3 or more, 2 or more, 3.1 or more, 4 or more, or 5 or more. The standard deviation (σ) of the aspect ratio may be 5 or less, 4 or less, 3.1 or less, 2 or less, or 1.3 or less.

The major axis diameter (d_{L}) of the crystallite 1 may be, for example, 0.3 μm or more, 0.4 μm or more, 0.5 μm or more, 0.6 μm or more, 0.9 μm or more, 1.2 μm or more, 1.5 μm or more, 1.6 μm or more, 1.8 μm or more, 2.0 μm or more, 2.2 μm or more, 2.3 μm or more, 2.5 μm or more, 3.0 μm or more, or 4.0 μm or more. The major axis diameter (d_{L}) of the crystallite 1 may be, for example, 5.0 μm or less, 4.0 μm or less, 3.0 μm or less, 2.5 μm or less, 2.3 μm or less, 2.2 μm or less, 2.0 μm or less, 1.8 μm or less, 1.6 μm or less, 1.5 μm or less, 1.2 μm or less, or 0.9 μm or less.

The minor axis diameter (d_{S}) of the crystallite 1 may be, for example, 0.10 μm or more, 0.15 μm or more, 0.21 μm or more, 0.24 μm or more, 0.30 μm or more, 0.40 μm or more, or 0.50 μm or more. The minor axis diameter (d_{S}) of the crystallite 1 may be, for example, 1.00 μm or less, 0.70 μm or less, 0.50 μm or less, 0.40 μm or less, 0.30 μm or less, 0.24 μm or less, or 0.21 μm or less.

In the present cathode active material, the relationship of “θ≤45°” is satisfied. The smaller the orientation angle (θ), the lower the initial resistance may be. The orientation angle (θ) may be, for example, 42.9° or less, 30° or less, 20° or less, 15° or less, 12.5° or less, 10° or less, 6.2° or less, or 2.6° or less. The orientation angle (θ) may be, for example, 0° or more, 1° or more, 2° or more, 2.6° or more, 6.2° or more, 10° or more, 12.5° or more, 15° or more, 20° or more, or 30° or more.

### Chemical Composition

The crystallite 1 includes a lithium metal composite oxide. The crystallite 1 may be composed of, for example, a single crystal. The crystallite 1 may be formed of a lithium metal composite oxide. A structure of the lithium metal composite oxide is a layered-rocksalt structure. The layered rock salt type structure is also referred to as “α-NaFeO₂ type structure”. The space group of the stratified rock salt type is “R-3m”. The crystallization can be determined by the powder XRD (X-ray diffraction) method.

The layered rock salt type structure has 100 faces and 003 faces. The layered rock salt construction includes a host layer 1a (metal-oxide layer) and a guest layer 1b (Li layer). The 100 planes may be orthogonal to each layer of the layered rock salt-type structure. The 003 plane may be parallel to each layer of the layered rock salt type structure. The 100 and 003 planes may be detected, for example, by TEM spectrometry. The crystallite 1 may have an end face 1c at both ends thereof. The end face 1c may serve as an entrance to and exit from Li. For example, 100 faces may be detected in the end face 1c. When the 100 surface is detected in the end face 1c, for example, during charging and discharging, Li can smoothly enter and exit.

The lithium metal composite oxide may have any chemical composition. The lithium metal composite oxide may have, for example, a composition represented by the following general formula.

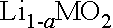

Where “−0.5≤a≤0.5” is satisfied. “M” includes at least one selected from the group consisting of Ni, Co, Mn, and Al.

The composition of the lithium metal composite oxide may be represented by, for example, the following general formula. The compounds represented by the formulae below may also be referred to as “NCM”.

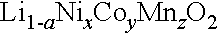

In the formula, “−0.5≤a≤0.5”, “0<x<1”, “0<y<1”, “0<z<1”, and “x+y+z=1” are satisfied. For example, relationships such as “0.5≤x<1”, “0<y≤0.25”, and “0<z≤0.25” may be satisfied.

The composition of the lithium metal composite oxide may be represented by, for example, the following general formula. Compounds represented by the formulae below may also be referred to as “NCA”.

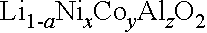

In the formula, “−0.5≤a≤0.5”, “0<x<1”, “0<y<1”, “0<z<1”, and “x+y+z=1” are satisfied. For example, relationships such as “0.5≤x<1”, “0<y≤0.25”, and “0<z≤0.25” may be satisfied.

A dopant may be added to the lithium metal composite oxide. The dopant may be diffused throughout the particle or may be locally distributed. For example, dopants may be unevenly distributed on the particle surface. The dopant may be a substituted solid solution atom or an infiltrated solid solution atom. The dopant may be an atom derived from a “crystal control material” described below. The dopant may include, for example, at least one selected from the group consisting of W and B.

The ratio of the material amount of the dopant to the material amount of the lithium metal composite oxide may be, for example, 0.01 or more, 0.05 or more, or 0.1 or more. The ratio may be, for example, 0.5 or less, 0.1 or less, or 0.05 or less.

A production method of a cathode active material, the production method comprising:

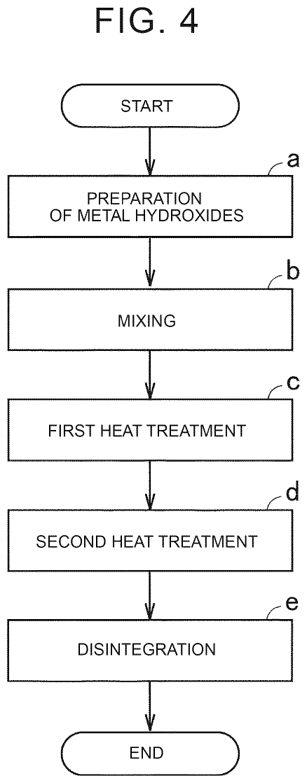

FIG. 4 is a schematic flowchart of a method for producing a cathode active material according to the present embodiment. Hereinafter, a method for producing a cathode active material according to the present embodiment may be abbreviated as a “bookbinding method”. The process includes “preparation of metal hydroxide”, “mixing”, “first heat treatment” and “second heat treatment”. The bookbinding method may further include, for example, “crushing” and the like.

### Preparation of Metal Hydroxides

The process includes providing a metal hydroxide. Metal hydroxides are precursors of lithium metal composite oxides. The metal hydroxide may be synthesized, for example, by a coprecipitation method or the like. For example, a sulfate salt may be provided. Sulfate may include at least one selected from the group consisting of, for example, NiSO₄, CoSO₄, MnSO₄, and Al₂(SO₄)₃. By dissolving the sulfate in water, a raw material solution is prepared. The concentration of the raw material solution may be, for example, 10 to 50% by mass fraction. By dropping the raw material solution into the alkaline aqueous solution, precipitation of the metal hydroxide can be generated. For example, the precipitate (metal hydroxide) may be recovered by filtration. After recovery, the metal hydroxide may be washed with water. After washing with water, the metal hydroxide may be dried.

### Mixing

The process includes mixing a metal hydroxide and a lithium compound to form a first mixture. For example, in a mortar or the like, mixing and grinding of the material may be performed.

“Lithium-compound” refers to a compound comprising Li. The lithium compound may include, for example, at least one selected from the group consisting of LiOH, and Li₂CO₃. Lithium compounds are Li sources of lithium metal composite oxide. The ratio of the amount of Li to the amount of the metallic hydroxide (precursor) may be, for example, 0.5 or more, 0.75 or more, 1 or more, 1.1 or more, or 1.25 or more. The ratio may be, for example, 1.5 or less, 1.25 or less, 1.1 or less, 1 or less, or 0.75 or less.

For example, a crystal control material may be added. That is, the first mixture may be formed by mixing a metal hydroxide, a lithium compound, and a crystal control material. The crystal control material is expected to promote an increase in the aspect ratio of the crystallites and a radial arrangement of the crystallites. The crystal-control material may comprise, for example, at least one selected from the group consisting of H₂WO₄ and B₂O₃. The ratio of the material amount of the crystal control material to the material amount of the metal hydroxide (precursor) may be, for example, 0.1 to 1. The ratio may be, for example, 0.5 or more, or 0.5 or less.

### First Heat Treatment and Second Heat Treatment

The process includes subjecting the first mixture to a first heat treatment to form a second mixture. The method further includes synthesizing the cathode active material by subjecting the second mixture to a second heat treatment. The first heat treatment and the second heat treatment are performed under an oxygen atmosphere.

The first heat treatment is performed at a low temperature for a short time. The temperature of the first heat treatment is 600 to 650° C. The temperature of the first heat treatment may be, for example, 610° C. or higher, or 625° C. or higher. The temperature of the first heat treatment may be, for example, 625° C. or less, or 610° C. or less. The time of the first heat treatment is 1 to 5 hours. The time of the first heat treatment may be, for example, 4 hours or less, 3 hours or less, or 2 hours or less. The time of the first heat treatment may be, for example, 2 hours or more, 3 hours or more, or 4 hours or more.

The second heat treatment is performed at a high temperature for a short time. The temperature of the second heat treatment is 900 to 1100° C. The temperature of the second heat treatment may be, for example, 950° C. or higher. The temperature of the second heat treatment may be, for example, 1050° C. or less. The time of the second heat treatment is 0.5 to 2 hours. The time of the second heat treatment may be shorter than the time of the first heat treatment. The time of the second heat treatment may be, for example, 1.5 hours or less. The total time of the first heat treatment and the second heat treatment may be, for example, 8 hours or less, 7 hours or less, 6 hours or less, 5 hours or less, or 4 hours or less. The total time of the first heat treatment and the second heat treatment may be, for example, 1 hour or more, 2 hours or more, or 3 hours or more.

### Disintegration

The process may include disrupting the lithium metal composite oxide. Any grinder (e.g., jet mill, etc.) can be used. The particle size of the lithium metal composite oxide may be adjusted by crushing.

### Production of Cathode Active Material

### No. 1

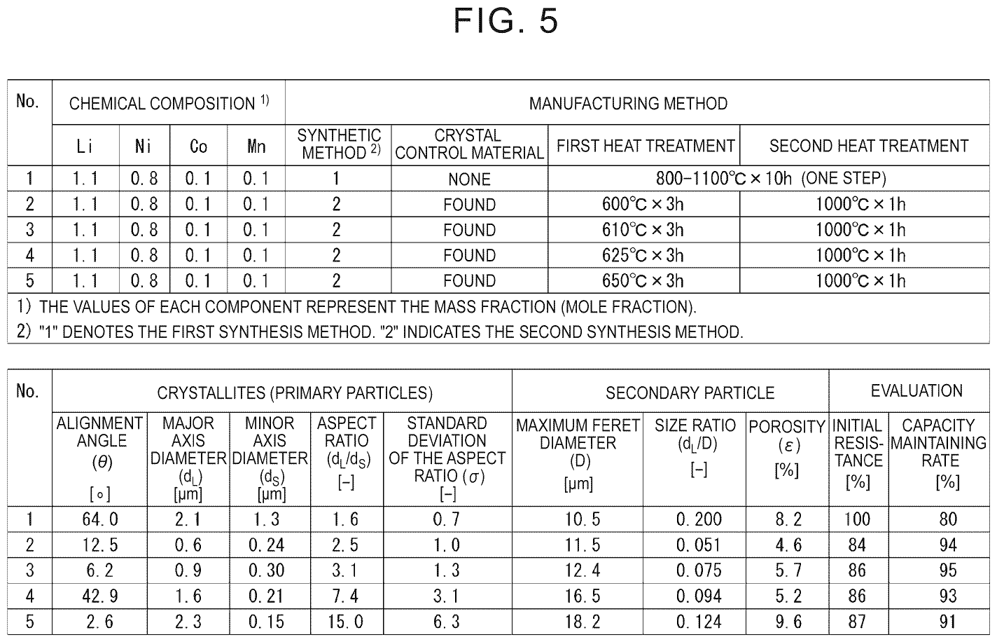

FIG. 5 is a table showing production conditions and experimental results. A No. 1 cathode active material was produced by the first synthetic process. The raw material solutions were formed by dissolving NiSO₄, CoSO₄, MnSO₄ in ion-exchanged water. In the feed solutions, the molar fraction of Ni, Co, Mn was “Ni/Co/Mn=8/1/1”. The concentration of the raw material solution was 30% by mass fraction.

Ammonia water was placed in the reaction vessel. The inside of the reaction vessel was replaced with nitrogen while the ammonia water was stirred by the stirrer. Further, the reaction solution was formed by charging NaOH into the reaction vessel.

Precipitation (metallic hydroxide) was formed by dropping the raw material solution and ammonia-water into the reaction liquid so that the reaction liquid maintained a certain pH. The reaction solution was filtered to recover the metal hydroxide. A dispersion was formed by dispersing the metal hydroxide in ion-exchanged water. The dispersion was sufficiently stirred by the spatula. That is, the metal hydroxide was washed with water. After washing with water, the dispersion was filtered to recover the metal hydroxide. The metal hydroxide was dried at 120° C. for 16 hours to form a dry matter.

In a mortar, the dry matter was mixed with a lithium compound (Li₂CO₃) to form a mix. The ratio of the amount of Li to the amount of metallic hydroxide material was 1.1.

In the muffle furnace, the mixture was subjected to a heat treatment to synthesize a lithium metal composite oxide. The heat treatment was one step. Conditions of the heat treatment were as follows. After the heat treatment, the particle size of the lithium metal composite oxide was adjusted by a jet mill.

Atmosphere: Oxygen atmosphere

### Temperature: 800-1100° C.

Time: 10 hours

### No. 2

A No. 2 cathode active material was produced by the second synthetic process. The second synthesis method differs from the first synthesis method with respect to the use of the crystal control material and the heat treatment. As with No. 1, a dry matter (metallic hydroxide) was prepared by the co-precipitation method.

In a mortar, a mixture was formed by mixing a dry matter, a lithium compound (Li₂CO₃), and a crystal-control material (H₂WO₄, B₂O₃). The ratio of the material amount of the crystal control material to the material amount of the metal hydroxide was 0.1.

In the muffle furnace, the lithium metal composite oxide was synthesized by performing the first heat treatment and the second heat treatment in this order. Conditions of the heat treatment were as follows. After the heat treatment, the particle size of the lithium metal composite oxide was adjusted by a jet mill.

### First Heat Treatment

Atmosphere: Oxygen atmosphere

### Temperature: 600° C.

Time: 3 hours

### Second Heat Treatment

Atmosphere: Oxygen atmosphere

### Temperature: 1000° C.

Time: 1 hour

### No. 3, No. 4, No. 5

As shown in FIG. 5, the cathode active material was produced in the same manner as No. 2 except that the temperature of the first heat treatment was changed.

### Evaluation

A cylindrical lithium-ion secondary battery (evaluation cell) was manufactured. The structure of the evaluation cell is as follows.

Power generation element: wound type

Positive electrode: cathode active material/AB/PVDF=88/10/2 (mass-ratio)
Negative electrode: negative electrode active material (natural graphite), CMC, SBR
Electrolyte: LiPF₆ (1 mol/L), EC/DMC/EMC=3/4/3 (volume)

The positive electrode and the negative electrode were manufactured by coating a slurry on the surface of a substrate (metal foil). As a coating apparatus, a film applicator (with a film thickness adjustment function) manufactured by All Good Co. was used. After coating the slurry, the coating was dried at 80° C. for 5 minutes.

The initial resistance of the evaluation cell was measured. Further durability tests of the evaluation cells were performed. That is, charge/discharge was repeated 200 times in a range of 3.0 to 4.1 V with a constant current of 2C at room temperature. The capacity retention ratio (percentage) was determined by dividing the 200th discharge capacity by the first discharge capacity. The higher the capacity retention ratio, the better the durability is.

### Results

The initial resistance in FIG. 5 is a relative value when the initial resistance of No. 1 is regarded as 100%. When the relation of “2.5≤d_{L}/d_{S}≤15”, “0.051≤d_{L}/D≤0.124” and “θ≤45°” is satisfied, the initial-resistance tends to decrease.

Furthermore, when the relation of “2.5≤d_{L}/d_{S}≤15”, “0.051≤d_{L}/D≤0.124” and “θ≤45°” is satisfied, durability tends to be improved. The end face 1c that is the entrance to and exit from Li may be referred to as a “reactive face.” An increase in the reaction surface is expected to reduce the initial resistance. On the other hand, the reaction between the reaction surface and the electrolyte can be accelerated. The reaction may consume Li to produce a coating. As a result, it is considered that the durability is lowered.

In the crystallite 1 (FIG. 2) having a large aspect ratio, the end face 1c (reactive face) is limited to both ends of the crystallite 1 in the long axis direction. That is, it is considered that the reaction surface is small. Since the reaction surface is small, it is considered that the durability is improved. Further, it is considered that Li inlet and outlet are radially arranged while the reactive surface is small, and the flow of Li in the crystallite 1 is rectified, so that the initial-resistance can be reduced.

What is claimed is:

1. A cathode active material comprising a secondary particle, wherein:
the secondary particle includes a plurality of crystallites;
each of the crystallites includes a lithium metal composite oxide;
the lithium metal composite oxide has a layered-rocksalt structure;
in a cross section of the secondary particle, relationships of 2.5≤d_{L}/d_{S}≤15, 0.051≤d_{L}/D≤0.124, and θ<45° are satisfied;
the d_{L} represents a major axis diameter of the crystallite, and the d_{S} represents a minor axis diameter of the crystallite;
the D represents a maximum Feret diameter of the secondary particle;
the θ represents an angle formed between a first straight line and a second straight line;
the first straight line is an extension line of the major axis diameter of the crystallite; and
the second straight line passes through an intersection of a circumscribed circle of the secondary particle and the extension line and through a center of the circumscribed circle.

2. The cathode active material according to claim 1, wherein in the cross section of the secondary particle, relationships of 0.051≤d_{L}/D≤0.094 and 2.5≤d_{L}/d_{S}≤7.4 are further satisfied.

3. The cathode active material according to claim 1, wherein in the cross section of the secondary particle, the secondary particle has a voidage of 5.7% or less.

4. The cathode active material according to claim 1, wherein a standard deviation of the d_{L}/d_{S} is 1.0 to 6.3.

5. A method for producing a cathode active material, the method comprising:
preparing a metal hydroxide;
forming a first mixture by mixing the metal hydroxide and a lithium compound;
forming a second mixture by subjecting the first mixture to first heat treatment; and
synthesizing the cathode active material by subjecting the second mixture to second heat treatment, wherein:
the first heat treatment and the second heat treatment are performed under an oxygen atmosphere;
the first heat treatment is performed at a temperature of 600° C. to 650° C. for 1 hour to 5 hours; and
the second heat treatment is performed at a temperature of 900° C. to 1100° C. for 0.5 hours to 2 hours.
